(19) United States
(12) Patent Application Publication
(10) Pub. No.: US 2009/0147798 A1
(43) Pub. Date: Jun. 11, 2009

(54) METHOD AND APPARATUS FOR DISASSOCIATION OF WIRELESS STATION IN A WIRELESS NETWORK

(75) Inventor: Javier del Prado Pavon, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,763

(22) PCT Filed: Nov. 16, 2005
(86) PCT No.: PCT/IB05/53787

§ 371 Date: May 21, 2007

Related U.S. Application Data
(60) Provisional application No. 60/630,081, filed on Nov. 22, 2004.

(51) Int. Cl. H04L 12/43

(52) U.S. Cl. 370/461

(57) ABSTRACT

A wireless network (100) includes a plurality of first wireless stations (101) and a plurality of second wireless stations (102). The first wireless stations are adapted to receive a frame (202, 401), which includes a duration value (207, 403) identifying a contention period (203, 402). The first wireless devices are adapted not to communicate during the contention period. The second wireless stations are adapted to communicate during the contention period. A method of wireless communication is also described.

The wireless communication bandwidth has increased significantly, making the wireless medium a viable alternative to wired and optical fiber solutions. As such, the use of wireless connectivity in data and voice communications continues to increase.

Normally, wireless devices (often referred to as stations) are employed in a wireless network, such as a wireless local area network (WLAN). Illustrative devices that may be used in a network include mobile telephones, portable computers, stationary computers in wireless networks, portable handsets, to name only a few.

Each wireless network includes a number of layers and sub-layers. The Medium Access Control (MAC) sub-layer and the Physical (PHY) layer are two of these layers. The MAC layer is the lower of two sublayers of the Data Link layer in the Open System Interconnection (OSI) stack. The MAC layer provides coordination between many users that require simultaneous access to the same wireless medium.

The MAC layer protocol includes a number of rules governing the access to the broadcast medium that is shared by the users within the network. As is known, several different multiple access technologies (often referred to as MAC protocols) have been defined to work within the protocols that govern the MAC layer. These include, but are not limited, to Carrier Sensing Multiple Access (CSMA), Frequency Division Multiple Access (FDMA) and Time Division Multiple Access (TDMA).

With continued and heightened interest in wireless connectivity, many advances at various levels of wireless systems have taken place at a very rapid pace. For example, new standards are being devised, encompassing new modulation schemes. These new standards often have a greater efficiency and throughput compared to their predecessors.

As can be appreciated, as these advances are made, there are potential incompatibility issues that may arise between existing (legacy) wireless protocols and stations that operate thereunder and the ‘new’ protocols and stations. For example, in many legacy IEEE 802.11 MAC protocols, it is incumbent upon a wireless station or device in a network to ‘listen’ before transmitting. Thus, a legacy 802.11 device will check the wireless medium for traffic before transmitting. Unfortunately, the legacy devices do not necessarily recognize many new modulation schemes. As such, a ‘new’ (non-legacy) device(s) may be accessing the medium when the legacy device is checking the medium. However, because the legacy device does not recognize the modulation scheme of the new device(s), the legacy device may incorrectly interpret that the medium is clear for transmission. This can result in collisions of transmissions within the network. If this occurs, the legacy network protocol based on ‘listen’ before transmit will fail.

One known method of avoiding the referenced deficiencies includes the incorporation of a request-to-send (RTS) frame followed by a clear-to-send (CTS) frame, which are used in many legacy 802.11 MAC protocols. In this method, an RTS frame must be transmitted by all devices (legacy and non-legacy); and a CTS must be received from an access point (AP) (in a centralized MAC protocol) by a device before it transmits a data frame. Moreover, in order for the legacy devices to recognize the RTS/CTS to effectively communicate, the RTS/CTS exchange is effected at legacy rates. As such, when non-legacy devices require medium access, the RTS/CTS is exchanged, followed by a data frame(s) at the new rates. As can be appreciated, the use of the RTS/CTS by all devices in a network fosters coexistence of legacy and non-legacy devices in a network, because the legacy devices remain idle for at least the duration of the data frame(s); and the new devices are free to access the medium in an unfettered manner.

While the known method requiring the use of a legacy RTS/CTS provides some improvement to problem of coexistence of legacy and non-legacy devices, the efficiency of such a scheme is less than optimal. For example, in order to ensure that legacy devices are always apprised of the status of the medium, the RTS/CTS must be exchanged at legacy rates by all devices. This encumbers the non-legacy devices. Moreover, the RTS/CTS is required for the transmission of each and every data frame. However, the RTS/CTS is transmitted at much lower rates than the rates of the new/non-legacy devices. Ultimately, the throughput and efficiency of such a system is less than optimal. In summary, while such a scheme may be useful in preserving the MAC protocols of the cohabitating non-legacy and legacy devices, the known scheme frustrates the efficiency and throughput potential of the non-legacy devices by forcing the non-legacy device to execute the RTS/CTS at legacy rates.

What is needed, therefore, is a method overcomes at least the shortcomings of the known methods referred to above.

In accordance with an example embodiment, a method of wireless communication includes providing at least one frame, which includes duration value identifying a contention period. The method also includes providing a plurality of first wireless stations, which may not communicate during the contention period; and providing a plurality of second wireless stations, which may communicate during the contention period.

In accordance with an example embodiment a wireless network includes a plurality of first wireless stations and a plurality of second wireless stations. The first wireless stations are adapted to receive a frame, which includes a duration value identifying a contention period. The first wireless devices are adapted not to communicate during the contention period. The second wireless stations are adapted to receive the frame and to communicate during the contention period.

The invention is best understood from the following detailed description when read with the accompanying drawing figures. It is emphasized that the various features are not necessarily drawn to scale. In fact, the dimensions may be arbitrarily increased or decreased for clarity of discussion.

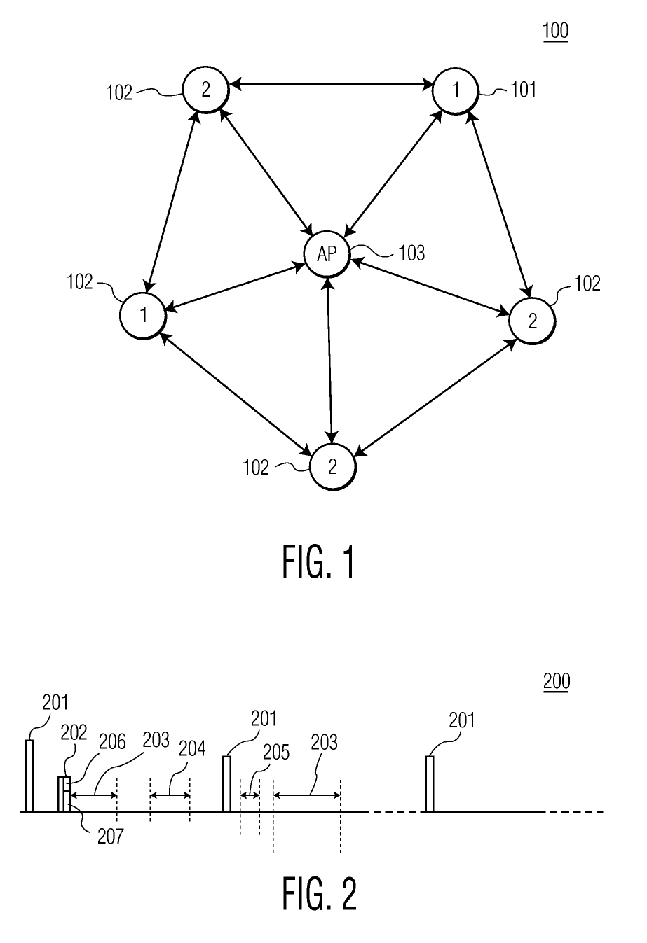

FIG. 1 is a schematic diagram of a wireless network in accordance with an example embodiment.

FIG. 2 is a timing diagram in accordance with an example embodiment.

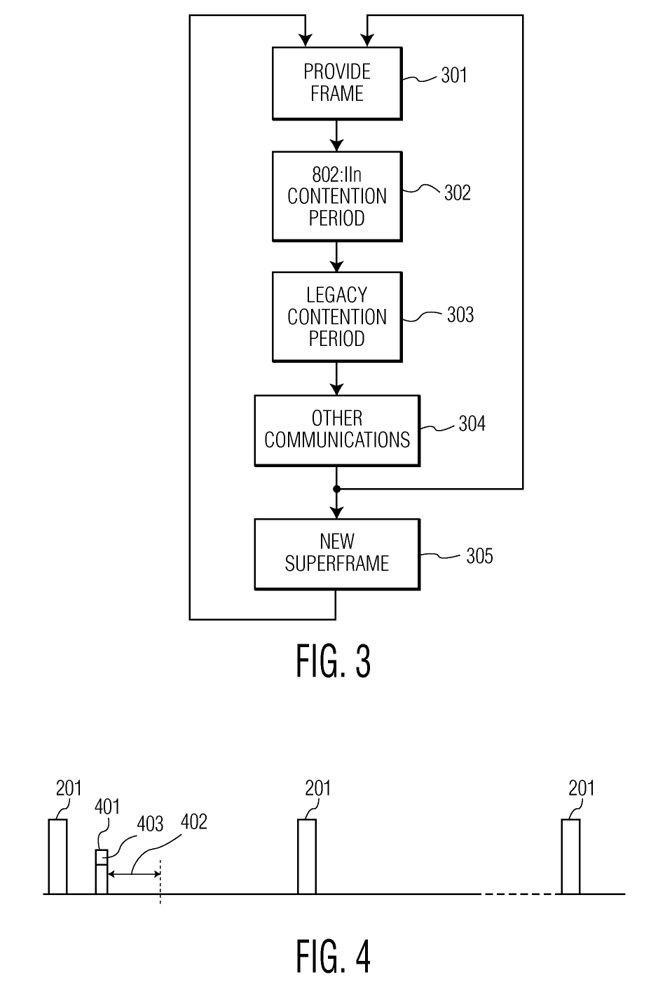

FIG. 3 is a method of wireless communication in accordance with an example embodiment.

FIG. 4 is a timing diagram in accordance with an example embodiment.

In the following detailed description, for purposes of explanation and not limitation, example embodiments disclosing specific details are set forth in order to provide a thorough understanding of the example embodiments. However, it will be apparent to one having ordinary skill in the art having had the benefit of the present disclosure that other embodiments that depart from the specific details disclosed herein. Moreover, descriptions of well-known devices, methods, systems and protocols may be omitted so as to not obscure the description of the example embodiments. Nonetheless, such devices, methods, systems and protocols that are within the purview of one of ordinary skill in the art may be used in accordance with the example embodiments. Finally, wherever practical, like reference numerals refer to like features.

Briefly, the example embodiments relates to wireless networks and methods of wireless communication. Illustratively, there are legacy stations (devices) as well as non-legacy (‘new’) devices in the network. In order to foster coexistence of the legacy and non-legacy devices, and to increase the efficient use of the medium, legacy traffic and non-legacy traffic are separated at least to some extent by selectively providing frames that are received and recognized by both legacy and non-legacy devices. The frames designate one or more intervals in which only non-legacy devices may access the medium of the network. In addition, the frames may designate one or more intervals during which only legacy devices may access the medium, or during which both legacy and non-legacy devices may access the medium.

It is noted that in the illustrative embodiments described herein, the network may be a wireless network with a centralized architecture. The wireless network includes wireless stations (STAs) with updated (non-legacy) modulation and frame formats as well as legacy STAs. Illustratively, the network may be one that functions under the IEEE 802.11 standard (legacy) and includes one or more wireless stations (STA's) having a MAC and PHY layers in compliance with IEEE 802.11n or any of its progeny. However, the example embodiments are not limited to MAC layers governed by the IEEE 802.11 standard. In fact, the example embodiments are applicable to a variety of centralized networks that include STAs that function under updated (i.e., non-legacy) modulation and frame formats as well as legacy STAs. These include, but are not limited to: cellular networks; wireless local area networks (WLAN); time division multiple access (TDMA) protocol; CSMA; CSMA with collision avoidance (CSMA/CA); and frequency division multiple access (FDMA). It is emphasized that these protocols are merely illustrative and that protocols other than those specifically mentioned may be used without departing from the example embodiments.

It is further noted that the networks of the example embodiments are not necessarily centralized. To this end, it is contemplated that the example embodiments may be incorporated into a distributed wireless network. To this end, the distributed network may perform the protocol described in the example embodiments to increase the efficiency of the network.

FIG. 1 is a schematic diagram of a wireless network 100 in accordance with an example embodiment. The wireless network 100 includes a centralized MAC layer within an AP (HOST) 103, which illustratively operates according to one of the plurality of illustrative protocols referenced above. The AP 101 services a number of first STAs (wireless devices) 101 and a number of second STAs 102 according to the chosen protocol. In the present example embodiment the first STAs 101 are legacy STAs (e.g., STAs with a MAC and PHY layers in compliance with IEEE 802.11); and the second STAs 102 are non-legacy STAs, functioning under an updated modulation and frame format (e.g., STAs with an 802.11n MAC and PHY layers.)

Illustratively, the network 100 is a WLAN, a wide area network (WAN) or mobile telephone network, and the STAs (devices) 101, 102 are computers, mobile telephones, personal digital assistants (PDA), or similar devices that typically operate in such networks. As indicated by the two-way arrows, the devices 101, 102 may communicate bilaterally; and the host 103 and devices 101, 102 may communicate bilaterally.

It is noted that according to certain MAC layer protocols, communication from one device of the STAs 101,102 to another of the STAs 101,102 is not necessarily direct; rather such communications pass through the host 103, which then transmits the communications (using known scheduling methods) to the correct recipient STA 101, 102.

It is further noted that while only a few STAs 101,102 are shown, this is merely for simplicity of discussion. Clearly, many other devices 101,102 may be used. Finally, it is noted that the devices 101,102 are not necessarily the same. In fact a plethora of different devices that function under the chosen protocol(s) may be used within the network 100.

FIG. 2 is a timeline 200 in accordance with the example embodiment, and is best understood when reviewed in conjunction with the illustrative embodiments of FIG. 1. At selected intervals the AP 103 of the (centralized) network 100 sends a beacon 201. As is known, the period between the beacons 201 is often referred to as a superframe. The beacons 201 are received within the range of the network 100. In an example embodiment, after receipt of the beacon 201 by the first devices 101, requests for service are made by the first devices 101. For example, the first devices 101 may operate under the 802.11 protocol. Such a protocol is often referred to as a ‘listen-before-talk’ protocol. As such, request-to-send (RTS) and clear-to-send (CTS) exchanges between the first STAs 101 and the AP 103 may occur after the receipt of the beacon 201. As can be appreciated, this process continues while one or more of the devices remain in the range of the host 101. Upon termination of a first superframe interval, another beacon 201 is transmitted indicating the commencement of a second superframe interval.

As referenced previously, because the legacy devices (e.g., STAs 101) are collocated in the network 100, there is the potential for failure of a ‘listen-before-talk’ protocol (e.g., 802.11). For example, because the legacy first STAs 101 do not recognize the protocol of the non-legacy second STAs 102, if one or more of the second STAs 102 is transmitting per its protocol, a first STA 101 will not recognize such a transmission, infer the network medium is clear, and may begin to transmit. This transmission by the first station(s) 101 may cause collisions within the network between first STA traffic and second STA traffic. As can be appreciated, this type of traffic collision can result in a failure of the protocol.

To substantially avoid these types of failures of the protocol(s) of the network, an example embodiment includes segregating the traffic of second STAs 102 to a particular interval(s) during a superframe. During this interval, the legacy first STAs 101 remain quiet, having been informed of the interval(s) via a frame from the AP 103. Beneficially, the first STAs 101 remain quiet and the second STAs 102 function according to their updated modulation and frame formats during the designated period. As will become clearer as the present description continues, the efficiency and throughput of not only second STAs 102 increases, but also the efficiency and throughput of the first STAs 101 increase as well, thereby increasing the efficiency and throughput of the network 100.

In accordance with an example embodiment, the efficient sharing of the network medium by first STAs 101 (legacy) and second STAs 102 (non-legacy) is effected as follows. The AP 103 transmits a frame 202 that is received by the first and second STAs of the network 100. The frame 202 includes at least two duration values. A first duration value 206 is included in the frame 202 received and recognized by the first STAs 101 and indicates a period during which they are not to access the network medium. This first duration value 206 is compliant with the existing protocol rules, to wit, the first STAs 101 understand that they are not clear-to-send during this period.

A second duration value 207 is also included in the frame 202. The second duration value 207 is only received by the second STAs 102 and indicates a contention period 203, during which only the second devices 102 are free to access the medium according to their updated/newer (i.e., non-legacy) modulation and frame rates. Notably, in the example embodiment, the second STAs 102 do not require a RTS/CTS exchange to send a data frame as is required in known networks that include legacy devices. Rather, during the contention period 203 of defined duration, only the second STAs 102 have unfettered access to the network medium. Clearly, the unfettered access to the medium allows the second STAs 102 the opportunity to communicate in accordance with their updated protocol.

While the example embodiment may include a separate frame 202 to provide the opportunity to separate legacy traffic from newer protocol traffic, this is not essential. Rather, the germane information of the start time and duration of the contention period 203 may be included in the beacon 201 of the superframe. For example, in the subsequent superframe, the contention period 203 is not preceded by a separate frame. Rather, the duration valves 206, 207 are included in the beacon 201. Finally, it is noted that there may be more than one contention period 203 in a superframe; and there does not need to be a contention period in each superframe.

In accordance with an example embodiment, during a superframe there may be one or more legacy contention periods 205, which are reserved for legacy first STAs 101 only. During the legacy contention period 204, the legacy devices, STAs 101, function according to known protocols. For example, if the legacy devices function in accordance with IEEE 802.11, for each data frame, there may be an RTS/CTS exchange. Moreover, the second STAs 102 may access the medium during the period 204, but must engage in an RTS/CTS exchange with the AP 103 for each frame as well. It is noted that this RTS/CTS exchanged is effected at legacy rates.

In yet another example embodiment, there may be a contention period 205, reserved exclusively for legacy devices. During this period 205, only legacy devices may access the medium.

It is noted that duration values associated with contention periods 204 and 205 are transmitted in frames 202 or beacons 201. For example, the duration value 207 may be associated with contention period 204. Alternatively, duration value 207 may be associated with contention period 205 and may be included in beacon 201. These duration values are recognized by the STAs affected by the duration value, and are in accordance with their respective protocols.

The example embodiments thus provide an opportunity to separate access of legacy devices and newer/updated devices in a wireless network. This increases the efficiency of both legacy and newer devices compared to known methods and networks. Beneficially, by providing separate opportunities for legacy traffic and non-legacy (e.g., IEEE 802.11n) traffic, the efficiency of the network 100 is increased for both legacy devices and non-legacy devices. As to the former, collisions that would have plagued the first STAs 101, but for the separated access, increases their efficiency within the network 100. Moreover, contention period 205 may be limited to only legacy devices further increasing efficiency and throughput. As to the latter, the limitation of the contention period 203 to the second STAs 102 provides the opportunity for improved modulation and frame rates to be used in an unfettered manner.

FIG. 3 is a flow chart of a method of wireless communication in accordance with an example embodiment. The method is understood best when reviewed in conjunction with the example embodiments described in connection with FIGS. 1 and 2. Moreover, the method includes many features that are common to the example embodiments previously described. While common features may be mentioned, they are generally not repeated so as to avoid obscuring the description of the method of the present example embodiment.

At Step 301 a frame is provided by transmission from the AP 103 to the STAs 101, 102 of the network 100. Illustratively, the frame includes a first duration value (e.g., first duration value 206) and a second duration value (e.g., second duration value 207). In an example embodiment, the frame may be transmitted as a separate frame within the superframe, or may be part of the beacon. The frame may include a multicast address. The multicast address includes the address of each of the second STAs 102 and specifically identifies the contention period 204 during which only the second STAs 102 may access the medium. Moreover, the frame includes the requisite frame received by all legacy devices precluding their access to the medium during the contention period 203 (i.e., not-clear-to-send) for a duration value commensurate with the contention period 203. As such, Step 301 includes information recognized by both types of STAs 101 and 102. The legacy devices (STAs 101) recognize a not-clear-to-send; and the newer devices (STAs 102) recognize the contention period information.

At Step 302, the contention period for STAs 102 is carried out. In an example embodiment, the STAs 102 include an 802.11n MAC and PHY layers, and thus the contention period is in accordance with this protocol.

At Step 303, a legacy contention period is effected. This contention period may be carried out in accordance with known protocols. For example, of the legacy devices (STAs 101) include an 802.11 MAC layer, the legacy contention period of Step 303 would require an RTS/CTS exchange between the newer devices and the AP 103 if the newer devices wish to transmit during this period. Step 303 contemplates contention period 204, or contention period 205, or both.

At Step 304, other communications may be effected within the network. These communications may be carried out following the contention free period access rules of 802.11, or following other legacy rules defined in 802.11.

After Step 304, the method may continue at step 305 with the commencement of the next superframe, or the method may repeat at Step 301.

It is noted that the order of Steps 302-304 is completely arbitrary. Moreover, the method does not require each Step to be carried out in each superframe. Finally, one or more of the Steps 301-304 may be repeated within each superframe.

FIG. 4 is a timing diagram in accordance with the example embodiment, and is best understood when reviewed in conjunction with the illustrative embodiments of FIGS. 1 and 2. The timing diagram includes superframes separated by beacons 201, with the time interval between beacons being equal to the superframe interval. The presently described example embodiments include many features that are common to the example embodiments previously described. While common features may be mentioned, such features are generally not repeated so as to avoid obscuring the description of the method of the present example embodiment.

In the example embodiment described in connection with FIG. 4, a poll frame 401 is transmitted to and received and recognized by one of the second STAs 102, which is not a legacy STA. Alternatively, the poll frame 401 may be transmitted to a select group of second STAs 102. The poll frame 401 includes a duration/id value 403 that will be recognized by all STAs 101, 102. Thus, the duration/id value 403 is transmitted in the legacy modulation and legacy frame format. During a contention period 402, only a designated second STA 102 (or designated STAs 102) may access the medium. As such, the non-designated second STAs 102 and all first STAs 101 must remain quiet during the period 402. Thus, during the period 402, the designated non-legacy STA(s) 102 has unfettered access to the medium.

In the example embodiment described in connection with FIG. 4, the poll frame 401 is transmitted during a superframe interval. This is illustrative, but not essential; the poll frame 401 may be transmitted with the beacon 201. Moreover, it is noted that more than one poll frame 401 may be transmitted during a superframe interval or included in a beacon. Finally, it is noted that in addition to the poll frame(s) 401, the AP may transmit other frames during the same superframe interval, such as those described in conjunction with the example embodiments previously described.

Among other benefits, the use of the poll frame 401 allows the non-legacy STAs 102 to communicate using higher modulation/channel bonding and other techniques to achieve higher data rates without concern of interference from legacy STAs 101. Moreover, the use of the poll frame allows one particular second STA 102 or a select group of second STAs 102 to transmit a relatively large amount of data in a relatively short period of time by limiting access to the medium to the one STA.

In view of this disclosure it is noted that the various methods and devices described herein can be implemented in hardware and software. Further, the various methods and parameters are included by way of example only and not in any limiting sense. In view of this disclosure, those skilled in the art can implement the various example devices and methods in determining their own techniques and needed equipment to effect these techniques, while remaining within the scope of the appended claims.

1. A method of wireless communication, the method comprising:
providing at least one frame (202), which includes a duration value (207, 403) identifying a contention period (203, 402);
providing a plurality of first wireless stations (101), which may not communicate during the contention period; and
providing a plurality of second wireless stations (102), which may communicate during the contention period.

2. A method as recited in claim 1, wherein the first wireless stations are legacy stations.

3. A method as recited in claim 1, wherein the second wireless stations are non-legacy stations.

4. A method as recited in claim 1, further comprising:
providing a legacy contention period (204, 205), during which the legacy devices may access the medium.

5. A method as recited in claim 4, wherein the non-legacy stations must transmit a request-to-send (RTS) and receive a clear-to-send (CTS) at legacy rates during the legacy contention period in order to access a medium of a wireless network.

6. A method as recited in claim 5, further comprising:
providing an access point (AP) (103), which receives the RTS and transmits the CTS.

7. A method as recited in claim 1, further comprising:
transmitting the frame during a superframe interval.

8. A method as recited in claim 1, further comprising:
transmitting the frame with a beacon (201).

9. A method as recited in claim 1, wherein the frame is a poll frame (401).

10. A method as recited in claim 9, wherein only one of the second wireless stations accesses a medium of a network during the contention period.

11. A wireless network (100), comprising:
a plurality of first wireless stations (101), which are adapted to receive a frame (202) that includes a duration value (207, 403) identifying a contention period (203, 402), wherein the first wireless stations are adapted to not communicate during the contention period; and
a plurality of second wireless stations (102), which are adapted to receive the frame and to communicate during the contention period.

12. A wireless network as recited in claim 11, wherein the first wireless stations are legacy stations.

13. A wireless network as recited in claim 11, wherein the second wireless stations are non-legacy stations.

14. A wireless network as recited in claim 11, further comprising an access point (AP) (103).

15. A wireless network as recited in claim 14, wherein the non-legacy stations must transmit a request to send (RTS) and receive a clear to send (CTS) from the AP at legacy rates during a legacy contention period (204) in order to access a medium of a wireless network.

16. A wireless network as recited in claim 14, wherein the AP transmits the frame and the frame includes at least one other duration value.

17. A wireless network as recited in claim 16, wherein the at least one other duration value identifies a legacy contention period.

18. A wireless network as recited in claim 17, wherein only the legacy stations may access the medium during the legacy contention period.

19. A wireless network as recited in claim 17, wherein both legacy stations and non-legacy stations may access the medium during the legacy contention period.

20. A wireless network as recited in claim 11, wherein the frame is a poll frame and only one of the second wireless stations accesses a medium of a network during the contention period.
